(19) United States
(12) Patent Application Publication
(10) Pub. No.: US 2018/0298515 A1
(43) Pub. Date: Oct. 18, 2018

(54) METHOD FOR MANAGING COPPER SULFATE PLATING SOLUTION

(71) Applicant: JCU CORPORATION, Tokyo (JP)

(72) Inventors: Tetsuro EDA, Kanagawa (JP); Hisayuki TODA, Kanagawa (JP); Kazuki KISHIMOTO, Kanagawa (JP); Yasuko TAKAYA, Kanagawa (JP); Ryoichi KIMIZUKA, Tokyo (JP)

(73) Assignee: JCU CORPORATION, Tokyo (JP)

(21) Appl. No.: 15/569,433

(22) PCT Filed: Apr. 27, 2015
(86) PCT No.: PCT/JP2015/062650

§ 371 Date: Oct. 26, 2017

(51) Int. Cl. C25D 21/12; C25D 3/38; C25D 21/18

(52) U.S. Cl. CPC C25D 21/12; G01N 24/08; C25D 21/18; C25D 3/38

(57) ABSTRACT

Instead of the renewal or purification of copper sulfate plating solutions performed based on the increase of defective products as an ex post facto measure or the empirical determination, a technique capable of managing copper sulfate plating solutions by assessing the aging of the copper sulfate plating solutions in an objective manner is provided. A method for managing a copper sulfate plating solution used for performing copper sulfate plating for a material to be plated, the method containing: measuring a concentration of impurities in the copper sulfate plating solution; and assessing aging of the copper sulfate plating solution from the concentration of the impurities.

### TECHNICAL FIELD

The present invention relates to a method for managing a copper sulfate plating solution, which assesses the aging of the copper sulfate plating solution by using a novel marker.

### BACKGROUND ART

Liquid management of copper sulfate plating solutions has been variously studied. Examples thereof having been widely employed include the plating liquid management method based on the appearance of plating by the Hull Cell test employed since old times, and also include the method in recent years based on concentration analysis of an additive by the electrochemical measurement method utilizing the polarization and depolarization of the additive by the cyclic voltammetry stripping (CVS). The method has also been proposed utilizing high-performance chromatography (HPLC) or capillary electrophoresis for the analysis of the additive.

However, the Hull Cell test requires actual plating performed, which not only requires considerable labor, but also makes the numerical management difficult. Furthermore, the other methods utilizing analysis of the additive focus only on the concentration of the additive, and thus the result thereof may not coincide with the actual plating result in some cases after using the plating solution for a prolonged period of time in the actual plating sites.

As another method than the above, the method utilizing total organic carbon (TOC) analysis for the liquid management of copper sulfate plating solutions has been proposed in recent years, but the TOC analysis is essentially the analysis method for measuring the concentration of general organic substances, and thus measures the total amount of the whole organic substances whether the substance is the effective ingredient of the additive, the decomposition product thereof, or an organic substance that does not adversely affect the plating, and therefore the result thereof may not coincide with the actual plating result in some cases.

Under the circumstances, such procedures have been practiced in the production sites of plating that the purification of the solution, such as an activated carbon treatment, or the renewal of the solution in a certain amount (for example, ⅕ of the total amount of the plating solution) or the whole amount is performed after assessing the aging of the plating solution by the reduction of yield, i.e., the increase of defective products, or after performing a certain electrolysis amount (for example, a certain processing time, e.g., an electrolysis amount reaching 200 AH/L or periodically once per month, or a certain plating amount, e.g., a processing amount of 100,000 m²), which is determined empirically.

### CITATION LIST

### Patent Documents

PTL 1: JP-A-2001-73183

PTL 2: JP-A-2001-73200

PTL 3: JP-A-2013-53338

PTL 4: JP-A-2005-171347

PTL 5: JP-A-2003-277998

PTL 6: JP-A-2002-322598

PTL 7: JP-A-2002-167699

PTL 8: JP-A-2006-317197

PTL 9: JP-A-2005-226085

PTL 10: JP-A-2004-53450

### SUMMARY OF INVENTION

### Technical Problem

Therefore, since the renewal or purification of copper sulfate plating solutions has been performed based on the increase of defective products as an ex post facto measure or the empirical determination, a technique capable of managing copper sulfate plating solutions by assessing the aging of the copper sulfate plating solutions in an objective manner has been widely demanded.

### Solution to Problem

As a result of investigations by the present inventors relating to impurities accumulated in copper sulfate plating solutions from various aspects, the impurities have been identified, and it has been found that the impurities cause deterioration of the properties of the plating film, the insufficiency of the demanded performance, such as the filling capability, and the like phenomena. The inventors have measured the concentration of the impurities in the copper sulfate plating solutions, and have found that the aging of the copper sulfate plating solutions can be assessed by the concentration of the impurities, and thus the invention has been completed.

The invention relates to a method for managing a copper sulfate plating solution used for performing copper sulfate plating for a material to be plated, the method containing: measuring a concentration of impurities in the copper sulfate plating solution; and assessing aging of the copper sulfate plating solution from the concentration of the impurities.

The invention also relates to a method for performing copper sulfate plating to a material to be plated by using a copper sulfate plating solution, the method containing: performing renewal or purification of the copper sulfate plating solution when the copper sulfate plating solution is determined to be aged by the aforementioned method for managing a copper sulfate plating solution.

### Advantageous Effects of Invention

The method for managing a copper sulfate plating solution of the invention can assess the aging of the copper sulfate plating solution in an objective manner, and thus renewal or purification of the copper sulfate plating solution can be performed in a planned manner.

The method for performing copper sulfate plating of the invention can perform renewal or purification of the copper sulfate plating solution in an objective manner by the aforementioned method for managing a copper sulfate plating solution, and thus defective products can be reduced as compared to the ordinary methods, thereby resulting in considerable cost saving.

### BRIEF DESCRIPTION OF DRAWINGS

FIG. 1 shows the results of ¹H-NMR measurement of the substances contained in the concentrate obtained in the item (1) of Example 1.

FIG. 2 shows the results of observation with a cross section metal microscope of the substrates subjected to copper sulfate plating with the copper sulfate plating solutions having various PDS concentrations in the item (2) of Example 1.

FIG. 3 shows the results of ESI-TOF-MS measurement of the substances contained in the concentrate obtained in the item (1) of Example 2.

FIG. 4 shows the appearance photographs of the substrates after the copper sulfate plating performed in the item (2) of Example 2.

FIG. 5 shows the HPLC charts of the copper sulfate plating solutions after the immersion treatment of 2,160 plies of the DFR obtained in the item (1) of Example 3.

### DESCRIPTION OF EMBODIMENTS

In the method for managing a copper sulfate plating solution of the invention (which may be hereinafter referred to the “method of the invention”), for a copper sulfate plating solution used for performing copper sulfate plating for a material to be plated, a concentration of impurities in the copper sulfate plating solution is measured, and aging of the copper sulfate plating solution is assessed from the concentration of the impurities. The aging of the copper sulfate plating solution referred in the description herein means a state where the impurities are accumulated in the copper sulfate plating solution beyond a certain concentration, which results in deterioration of the properties of the plating film and the insufficiency of the demanded performance, such as the filling capability.

In the method of the invention, the material to be plated and the copper sulfate plating solution used may be any of the known materials with no particular limitation. For example, the material to be plated is preferably such a material as a resin having been subjected to a conductive treatment, a metal, and the like, and particularly preferably an epoxy substrate and a silicon wafer. The copper sulfate plating solution is preferably a via filling plating solution, which is necessarily managed strictly, and particularly preferably a copper sulfate plating solution for fine wiring plating or via filling plating on a material having a blind via hole, a contact hole, a through hole, or a wiring trench.

Examples of the basic composition of the copper sulfate plating solution that can be applied to the method of the invention include the following. A brightener, a suppressor, a leveler, and the like, which are known in the art may be added to the basic composition depending on necessity.

Copper sulfate: 10 to 350 g/L

Sulfuric acid: 10 to 250 g/L

Chlorine: 5 to 100 mg/L

Water: appropriate amount

In the method of the invention, the impurities in the copper sulfate plating solution are materials that are not the effective ingredients of the copper sulfate plating, and deteriorate the properties of the plating film or make the demanded performance, such as the filling capability, insufficient. Examples of the impurities include an impurity derived from the material to be plated, an impurity derived from an additive of the copper sulfate plating solution, and an impurity contained in the copper salts for replenishment.

Examples of the impurity derived from the material to be plated include an eluted material from a dry resist film, and more specifically include an aromatic hydrocarbon having a carboxyl group or a hydroxyl group derived from the base resin or the photosensitive agent.

Examples of the impurity derived from the additive of the copper sulfate plating solution include an oxidation decomposition product of the additive, for example, a brightener component containing a sulfur compound or the like, such as bis(3-sulfopropyl) disulfide, a leveler component containing a nitrogen-containing organic compound, such as Janus Green B, a polyether, and a polyamine, and a suppressor component containing a polyether compound, such as polyethylene glycol, or a polyamine, such as polydiallylamine, and a decomposition product of a low molecular weight compound or the like.

Examples of the impurity contained in the copper salts for replenishment include a slight amount of a metal other than copper.

More specifically, examples of the impurity derived from the additive of the copper sulfate plating solution include an oxidation decomposition product of a sulfur compound, such as a propanedisulfonate salt, an oxidation decomposition product or low molecular weight compound of a polyether, such as polyethylene glycol 200 and/or a polyamine, such as dimethylallylamine, and a slight amount of a metal other than copper.

The concentration of the impurities in the copper sulfate plating solution can be measured, after performing various pretreatments, by any one measurement method selected from chromatography, such as high-performance liquid chromatography and ion chromatography, mass analysis, such as electrospray-ionization tandem quadrupole time-of-flight mass analysis, nuclear magnetic resonance, such as ¹H-NMR, electrophoresis, such as capillary electrophoresis, and atomic absorption, such as flame atomic absorption, or by combining plural measurement methods selected therefrom depending on necessity. The aging of the copper sulfate plating solution can be determined, for example, in such a manner that the concentration range of the impurities and the aging of the copper sulfate plating solution are correlated to each other in advance, and the aging of the copper sulfate plating solution is assessed as to whether or not the measured concentration of the impurities is in the range.

Specifically, in the case where the impurities in the copper sulfate plating solution are an eluted material from the dry resist film, the concentration thereof can be measured in such a manner that the plating solution is filtered with a filter of 0.2 μm and measured with high-performance liquid chromatography (HPLC) equipped with an UV detector, and the peak area detected in the prescribed retention time is compared to the peak area of the known extract. When the concentration of the eluted material from the dry resist film reaches, for example, from 300 to 1,000 mg/L or more, and preferably 200 mg/L or more, in the copper sulfate plating solution, it is determined that the aging of the copper sulfate plating solution is assessed, and the copper sulfate plating solution is necessarily renewed or purified. The aforementioned determination standard for the aging obviously may vary depending on the kind of the dry resist film, the kind of the process (additive), and the demanded accuracy of plating.

In the case where the impurities in the copper sulfate plating solution are a low molecular weight material of a polyether, the concentration thereof can be measured, for example, in such a manner that the copper sulfate plating solution is neutralized for the acid therein, from which the ionic nitrogen compound is removed by passing the copper sulfate plating solution, for example, through a cellulose ion exchange column using CM52 or the like as a carrier, the resulting elute is concentrated and, after appropriately diluting, measured for the precise molecular weight thereof by an electrospray-ionization tandem quadrupole time-of-flight mass spectrometer (ESI-TOF-MS), and the concentration of the impurities is obtained from the intensity ratio of the ion amount thereof with respect to the standard sample. In the case where the molecular weight of the low molecular weight material of a polyether is approximately from 50 to 300, in particular, the identification of the components can be performed with gas chromatography/mass spectrometer (GC/MS), and the amount thereof can be obtained from the intensity ratio of the total ion amount with respect to the standard sample. In this case, the gas chromatography may use, for example, a methylsilicone column, such as HP-5MS, and the separation temperature may be from 60 to 280° C. When the concentration of the low molecular weight material of a polyether reaches, for example, from 2,000 to 5,000 mg/L or more, and preferably from 1,500 to 2,500 mg/L or more, in the copper sulfate plating solution, it is determined that the aging of the copper sulfate plating solution is assessed, and the copper sulfate plating solution is necessarily renewed or purified. The aforementioned determination standard for the aging obviously may vary depending on the kind of the process (additive) and the demanded accuracy of plating.

In the case where the impurities in the copper sulfate plating solution are a propanedisulfonate salt, the concentration thereof can be obtained by measuring with ion chromatography, and comparing the peak area thereof to the calibration curve. When the concentration of the propanedisulfonate salt reaches, for example, from 400 to 500 mg/L, and preferably from 200 to 300 mg/L or more, in the copper sulfate plating solution, it is determined that the aging of the copper sulfate plating solution is assessed, and the copper sulfate plating solution is necessarily renewed or purified. The aforementioned determination standard for the aging obviously may vary depending on the kind of the process (additive) and the demanded accuracy of plating.

In the case where the impurities in the copper sulfate plating solution are a slight amount of a metal other than copper, the concentration thereof can be obtained by measuring with an atomic absorption photometer. When the concentration of the metal is increased to deteriorate the properties of the plating film or to make the demanded performance, such as the filling capability, insufficient, it is determined that the aging of the copper sulfate plating solution is assessed, and the copper sulfate plating solution is necessarily renewed or purified. The aforementioned determination standard for the aging obviously may vary depending on the kind of the process (additive) and the demanded accuracy of plating.

The method of the invention described above can be incorporated to an ordinary copper sulfate plating process, and in the case where the aging of the copper sulfate plating solution is assessed by the method of the invention, the copper sulfate plating solution may be renewed or purified. By the procedures, defective products can be prevented from being formed immoderately, problems including defective plating and reduction of yield can be prevented from occurring in advance, and the purification or renewal work of the plating solution, which is performed while terminating the operation on the site, can be performed in a planned manner.

The renewal or purification of the copper sulfate plating solution may be performed based on the known method, and examples thereof include replacement of the solution, such as partial renewal of ⅕ amount and total amount renewal, entire replacement of the copper sulfate plating solution, an activated carbon treatment, and a purification treatment by circulating the copper sulfate plating solution through an activated carbon cartridge while leaving the copper sulfate plating solution in the tank.

### EXAMPLES

The invention will be described in more detail with reference to examples below, but the invention is not limited to the examples.

### Example 1

Confirmation of Influence of Impurities Derived from Additive (Brightener)

### (1) Identification of Impurities in Copper Sulfate Plating Solution

Via filling plating was performed for a substrate having a via with a copper sulfate plating solution shown in Table 1 below, and the plating solution under the plating operation (i.e., the operating solution) was collected in an amount of from 6 to 20 mL, and neutralized for the acid therein, from which the polymer was then extracted and removed with chloroform.

TABLE 1

| Component | Amount | |
|---|---|---|
| Copper sulfate pentahydrate | 200 | g/L |
| Sulfuric acid | 50 | g/L |
| Chlorine | 50 | mg/L |
| Suppressor *¹ | 20 | mL/L |
| Brightener *² | 5 | mL/L |
| Leveler *³ | 5 | mL/L |

| | |
|---|---|
| Water | balance |

*¹ containing 200 mg/L of PEG4000
*² containing 5 mg/L of bis(3-sulufopropyl) disulfide
*³ containing 10 mg/L of amine compound

After sufficiently concentrating the aqueous layer after removing the polymer, approximately 0.5 mL of deuterated water (D₂O) was added thereto to dissolve the concentrate again. The ¹H-NMR spectrum of the substance contained in the concentrate was measured with a 400 MHz nuclear magnetic resonance (NMR) spectrometer, and as a result, signals were found at 2.1-2.3 (2H, m) and 2.9-3.1 (4H, m) ppm corresponding to disodium propanedisulfonate (PDS) (FIG. 1).

The substance contained in the concentrate was measured for the precise mass thereof by an electrospray-ionization tandem quadrupole time-of-flight mass spectrometer (EST-TOF-MS), and as a result, a peak of a molecular weight of 224.9508 corresponding to PDS was found in the plural molecular weights.

From the results of ¹H-NMR and ESI-TOF-MS, the presence of PDS as an impurity in the copper sulfate plating solution was confirmed. PDS is an oxidation decomposition product of bis(3-sulfopropyl) disulfide (SPS) added to the copper sulfate plating solution.

### (2) Influence of Impurities on Copper Sulfate Plating Solution

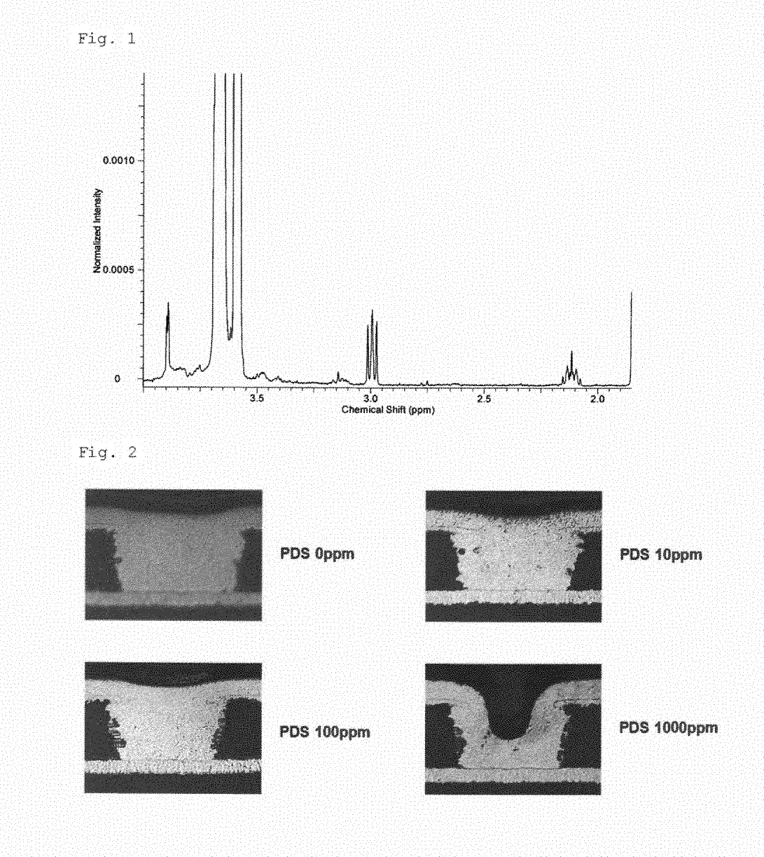

To the copper sulfate plating solution shown in Table 1, PDS was further added in an amount of 0, 10 ppm, 100 or 1,000 ppm. A substrate having a blind via hole (120 in diameter, 65 in depth) was immersed in each of the plating solutions, and copper sulfate plating was performed at 1.5 A/dm² targeting a film thickness of 20 μm. The film thickness and the dent (i e., the dent amount at the via center with respect to the flat portion around the via) were calculated from the results of observation with a cross section metal microscope (FIG. 2). The results are shown in Table 2.

TABLE 2

| Amount of PDS added (ppm) | Film thickness (μm) | Dent (μm) |
|---|---|---|
| 0 | 17.55 | 9.45 |
| 10 | 18.69 | 7.14 |
| 100 | 18.91 | 10.83 |
| 1,000 | 20.69 | 60.92 |

It was found that when the concentration of PDS, which was an oxidation decomposition product of SPS, in the copper sulfate plating, the filling capability was deteriorated. It can be determined from the result that the copper sulfate plating solution is aged when the concentration of PDS is 200 mg/L or more.

### Example 2

Confirmation of Influence of Impurities Derived from Additive (Suppressor)

### (1) Identification of Impurities in Copper Sulfate Plating Solution

A printed board was plated with the same copper sulfate plating solution shown in Table 1 as in Example 1, the plating solution under the plating operation was collected in an amount of from 6 to 20 mL, and after neutralizing the acid therein, the ionic nitrogen compound was removed by passing the solution through a cellulose ion exchange column (carrier: CN52, 1 cm in diameter, 15 cm in length), and the elute was concentrated. Pure water was added to the concentrate to control the concentration of approximately from 30 to 100 ppm.

An appropriate amount of the solution prepared above was introduced to ESI-TOF-MS and measured for the precise mass thereof. As a result, peaks of polyethers having decreased molecular weights corresponding to HO(CH₂CH₂O)ₙH (n=2 to 15) were found (FIG. 3).

### (2) Influence of Impurities on Copper Sulfate Plating Solution

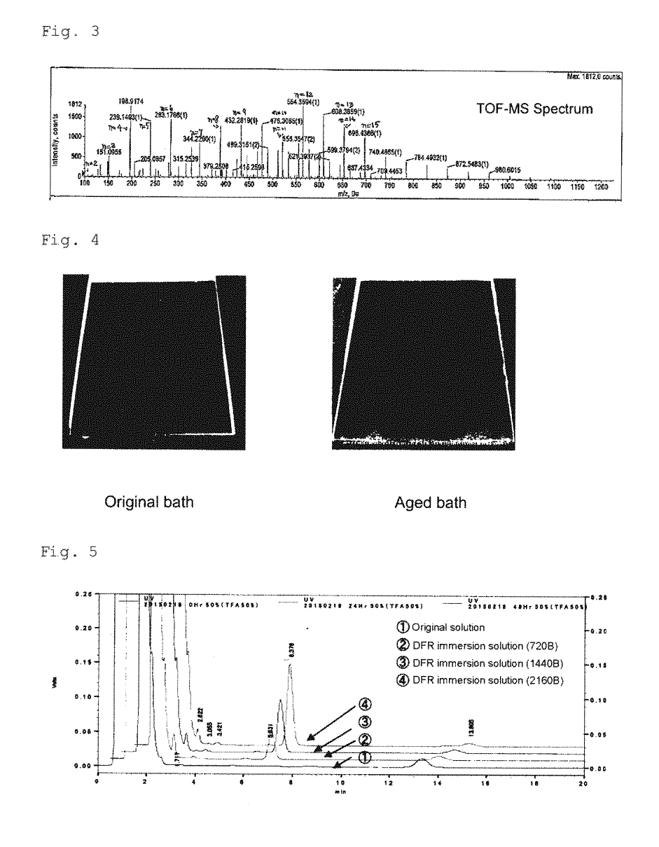

A copper sulfate plating solution shown in Table 3 was prepared. To the solution, the brightener and the leveler that were the same kinds and the same amounts as used in the copper sulfate plating solution shown in Table 1 in Example 1 were added to prepare an original bath. The plating solution of Table 3 was subjected to electrolysis by 300 AH while retaining the effective suppressor concentration (replenishment) through analysis, to which the brightener and the leveler were added in the same manner as in the original bath to prepare an aged bath. By using these solutions, the same substrate as used in Example 1 (i.e., the substrate having a blind via hole (120 in diameter, 65 in depth)) was subjected to copper sulfate plating. The appearance photographs of the substrates after the plating are shown in FIG. 4.

TABLE 3

| Component | Amount | |
|---|---|---|
| Copper sulfate pentahydrate | 200 | g/L |
| Sulfuric acid | 50 | g/L |
| Chlorine | 50 | mg/L |
| Suppressor *¹ | 20 | mL/L |

| | |
|---|---|
| Water | balance |

*¹ containing 200 mg/L of PEG4000

No significant influence on the filling capability was found in both the original bath and the aged bath. However, it was found that in the case using the aged solution, depositions in the form of protrusions (burnt deposits) were increased at the outer periphery and the end portions of the substrate, which deteriorated the on-site workability.

A smoothened stainless steel plate SUS304 was plated to a thickness of 50 μm with each of the original bath and the aged bath at 2 A/dm² for 120 minutes. Thereafter, the plating film was released to provide a copper film having a thickness of 50 μm. As for the elements incorporated into the plating film, carbon and sulfur were measured by the combustion infrared absorption method, and nitrogen and oxygen were measured by the inert gas fusion infrared absorption method and the thermal conductivity method. The elongation thereof was measured with a tensile tester (produced by Shimadzu Corporation). The results are shown in Table 4.

TABLE 4

| | | | | | | Elongation |
|---|---|---|---|---|---|---|
| | | | | | | (%) |
| | | | | | | average |
| | Elemental analysis value (mass %) | | | | | value |
| | Carbon | Sulfur | Oxygen | Nitrogen | Total | of n = 3 |
| Original | 0.0009 | <0.0003 | 0.0011 | 0.0005 | 0.0025 | 31 |
| bath | | | | | | |
| Aged bath | 0.0012 | 0.0007 | 0.0022 | 0.0006 | 0.0047 | 26 |

It was found that the polyether having a decreased molecular weight was incorporated into the plating film and lowered the properties of the film, such as the elongation.

It was clarified from the results that in the copper sulfate plating solution, the concentration of the polyether having a decreased molecular weight also related to the aging of the copper sulfate plating solution.

### Example 3

Confirmation of Influence of Impurities Derived from Material to be Plated

### (1) Identification of Impurities in Copper Sulfate Plating Solution

2,160 boards in total of copper-clad epoxy substrates having a dry film resist (DFR) (produced by Hitachi Chemical Co., Ltd.) adhered thereon were immersed in the copper sulfate plating solution shown in Table 1. Appropriate amounts of the solutions (i.e., the original solution, the solution after immersing 720 boards, the solution after immersing 1,440 boards, and the solution after immersing 2,160 boards) were subjected to HPLC under the following conditions.

### HPLC Analysis Conditions

Column: ODS (inner diameter: 4.6 mm, length: 50 mm)

Column temperature: 40° C.

Carrier liquid: buffer-added 50% methanol-water

Flow rate: 0.8 mL/min

Detector (measured wavelength): UV detector (210 to 280 nm)

Injection amount: 50 to 400 μL

As a result of HPLC, a peak based on the eluted material from DFR was found at a retention time of approximately 7 minutes in all the solutions except for the original solution. The peak was increased in substantially proportion to the processed area (FIG. 5). It is considered that the substance corresponding to the peak is derived from an aromatic hydrocarbon having a carboxyl group or a hydroxyl group eluted from the dry resist film since the substance has absorption at 240 to 320 nm and a maximum absorption wavelength of 272 nm.

### (2) Influence of Impurities on Copper Sulfate Plating Solution

Copper sulfate plating was performed by using the aforementioned plating solutions, and the dent after plating was observed with a cross section SEM, in the same manner as in the item (2) of Example 1, and as a result, the dent on the blind via hole with a surface plating thickness of 20 μm was from 30 to 35 μm (n=5).

It was clarified from the results that in the copper sulfate plating solution, the concentration of the eluted material from DFR also related to the aging of the copper sulfate plating solution.

### Example 4

### Management of Copper Sulfate Plating Solution

In a 200 L plating tank, a continuous electrolysis test was performed by using the copper sulfate plating solution shown in Table 1 and a test substrate having a blind via hole. The management of the copper sulfate plating solution was performed according to the basic composition analysis by titration and the concentration analysis of the additive by cyclic voltammetry stripping analysis. It addition to the analysis, the concentration of the impurities (PDS and the polyether having a decreased molecular weight) was periodically measured.

When the PDS in the copper sulfate plating solution reached 200 mg/L, or the polyether having a decreased molecular weight therein reached 2,000 mg/L, the solution was purified by treating with an activated carbon cartridge. The operation was repeated three times. It was confirmed by HPLC that the treatment with activated carbon removed PDS and the polyether having a decreased molecular weight in the copper sulfate plating solution.

Over the period of the continuous electrolysis test, the via filling capability showing the plating performance was able to be suppressed to a dent within the allowable range. The formation of burnt protrusions at the end portions of the substrate showing the influence of the polyether having a decreased molecular weight was also able to be suppressed to the allowable range.

It was shown by the results that in copper sulfate plating, the management of the concentration of the impurities in the copper sulfate plating solution enables renewal of the copper sulfate plating solution in an objective manner, and thereby defective products can be reduced.

### INDUSTRIAL APPLICABILITY

According to the method of the invention described above, the measurement of the concentration of the impurities in the solution in on-site operation enables the management of the on-site solution for retaining the plating performance demanded in the site or the product (i.e., the material to be plated), and as a result, the reduction in yield and defective plating in the site can be prevented in advance.

1. A method for managing a copper sulfate plating solution used for performing copper sulfate plating for a material to be plated, the method comprising:
measuring a concentration of impurities in the copper sulfate plating solution; and
assessing aging of the copper sulfate plating solution from the concentration of the impurities.

2. The method for managing a copper sulfate plating solution according to claim 1, wherein the impurities comprise at least one of:
an impurity derived from the material to be plated; and
an impurity derived from an additive of the copper sulfate plating solution.

3. The method for managing a copper sulfate plating solution according to claim 2, wherein the impurities comprise the impurity derived from an additive of the copper sulfate plating solution, said impurity being a decomposition product of a polyether, a polyamine, or both.

4. The method for managing a copper sulfate plating solution according to claim 2, wherein the impurities comprise the impurity derived from the material to be plated, said impurity being an eluted material from a dry resist film.

5. The method for managing a copper sulfate plating solution according to claim 2, wherein the impurities comprise the impurity derived from an additive of the copper sulfate plating solution, said impurity being an oxidation decomposition product of a sulfur compound.

6. The method for managing a copper sulfate plating solution according to claim 5, wherein the oxidation decomposition product of a sulfur compound is a propanedisulfonate salt.

7. A method of plating a material with a copper sulfate plating solution, the method comprising:
performing renewal or purification of the copper sulfate plating solution when the copper sulfate plating solution is determined to be aged by the method of claim 1.
